(19) United States
(12) Patent Application Publication
(10) Pub. No.: US 2013/0291099 A1
(43) Pub. Date: Oct. 31, 2013

(54) NOTIFICATION SERVICES WITH ANOMALY DETECTION

(71) Applicants: Paul A. DONFRIED, Richmond, VA (US); Peter S. TIPPETT, Great Falls, VA (US); Scott N. KERN, Salt Lake City, UT (US); Vidhyaprakash RAMACHANDRAN, Richardson, TX (US)

(72) Inventors: Paul A. DONFRIED, Richmond, VA (US); Peter S. TIPPETT, Great Falls, VA (US); Scott N. KERN, Salt Lake City, UT (US); Vidhyaprakash RAMACHANDRAN, Richardson, TX (US)

(73) Assignee: VERIZON PATENT AND LICENSING, INC., Basking Ridge, NJ (US)

(21) Appl. No.: 13/455,680

(22) Filed: Apr. 25, 2012

(51) Int. Cl. G06F 21/00

(52) U.S. Cl. 726/22

(57) ABSTRACT

A system is configure to monitor financial and/or identification inquiries for anomalous behavior; identify anomalous behavior by comparing the financial and/or identification inquiries to historical financial transactions and/or identification information; send a notification to a mobile device when anomalous behavior is identified for a user of the mobile device; and receive a signal from the mobile device approving, denying, or requesting more information about the anomalous behavior.

### BACKGROUND

Identity theft is becoming more and more prevalent as individuals share various details of that individual's personal, financial, and professional information. For example, to complete a commercial transaction with a vendor, an individual may provide some type of payment information, such as a credit card or checking account number. The vendor may further request, from the individual, additional information that may not be directly related to the transaction but that may be used to verify other information received for the transaction. For example, the vendor may request a user identification that may provide, for example, the individual's name, address, driver's license number, and/or other biographical information, and use this additional information to authenticate the individual.

The individual often provides this information with few, if any, safeguards as to how the vendor or a third party may use this information. Methods of safeguarding this information have been aimed at financial institutions that can contact an individual when potentially malicious behavior is identified by the financial institution. In order to limit the financial institution's liability, the financial institution has monitored an individual's spending activity and when a purchase that does not appear to be consistent with an individual's behavior pattern is noticed, the financial institution has informed the individual by telephone to confirm whether the anomalous purchase was actually done by the individual.

### BRIEF DESCRIPTION OF THE DRAWINGS

FIG. 1 is a diagram of an example environment in which a notification and anomaly detection system and method described herein may be implemented;

FIG. 2 is a diagram that illustrates an example environment in which systems and/or methods, described herein, may be implemented;

FIG. 3 is a diagram of example components of a device that may be used within the environment of FIG. 2;

FIG. 4 is a flowchart of an example process for notifying a user of an anomaly;

FIG. 5A illustrates an example user interface for setting a risk threshold level for notification according to an implementation;

FIG. 5B illustrates an example user interface for providing a notification to a user of a mobile device according to an implementation;

FIG. 6 illustrates an example user interface that provides a notification of transaction information according to an implementation; and

FIG. 7 illustrates an example user interface that provides a notification in the form of a message according to an implementation.

### DETAILED DESCRIPTION OF PREFERRED EMBODIMENTS

The following detailed description refers to the accompanying drawings. The same reference numbers in different drawings may identify the same or similar elements. Also, the following detailed description does not limit the embodiments.

A system and/or method described herein may provide notifications to a user of the user's transactions and/or behavior that appear to be different from the user's behavior pattern, which can indicate identity theft or malicious use of the user's financial or identity information. By providing notifications directly to a user, the user can have immediate knowledge of activity occurring with the user's financial or identity information and can be able to discern identity theft, fraud, etc. more accurately than others, such as financial institutions. For example, the user should be able to discern anomalies from the patterns that can occur due to changes in a user's transaction patterns (e.g., special occasions, traveling abroad, etc.) compared to anomalies that occur due to malicious uses of the user's identity (e.g., a stolen credit card number).

The system and/or method described herein can also use anti-fraud technologies, such as predictive analytics, anomalies in patterns, such as patterns of a specific user, a specific enterprise, or groups of multiple users or multiple enterprises.

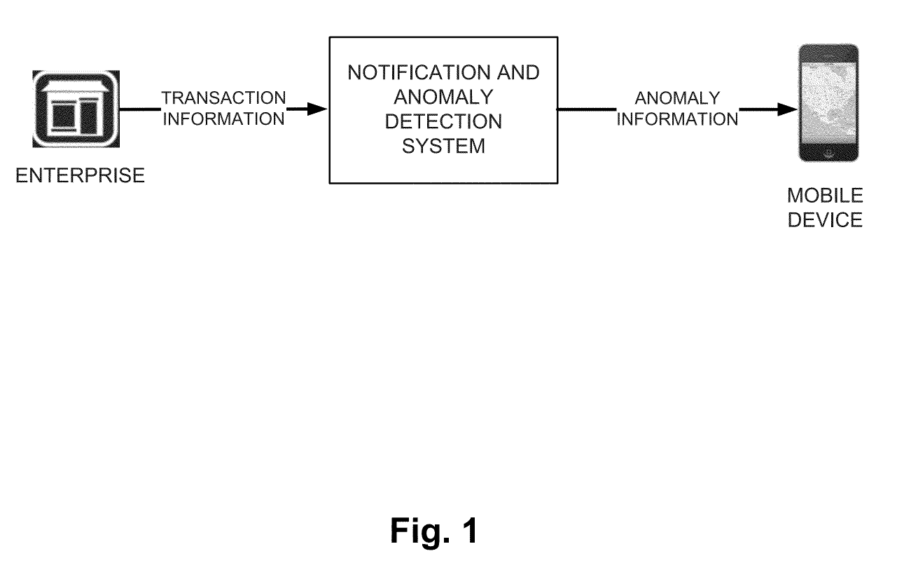

FIG. 1 is a diagram of an example environment in which a notification and anomaly detection system and method described herein may be implemented. As illustrated in FIG. 1, an enterprise (e.g., businesses, financial institutions, etc.) can provide transaction information (e.g., business name, location, purchase amount, time of purchase, etc.) to a notification and anomaly detection system. A notification and anomaly detection system can gather and analyze transaction information (along with other transaction information from other enterprises) to find patterns in transaction information and anomalies to the patterns. The results of the analysis can be anomaly information, which can be combined with transaction information. Anomaly information (along with transactional information) can be provided to a user of a mobile device to identify malicious activity, such as identity theft activity (e.g., misuse of a name, a Social Security number, a credit card number, other financial account information, etc.). A notification threshold level can also be set and if an anomalous transaction exceeds the notification threshold level, then the anomaly information and the transactional information can be provided via a network to the user.

In one implementation, a user can notified about any transaction, and upon reviewing a notification can identify authentic and malicious activity on a transactional basis. For example, a credit card authorization request from a merchant to a credit card company can create a notification that a user can use to identify whether the credit card authorization request is based on an authentic transaction by the user or on a malicious activity transaction by an identity thief.

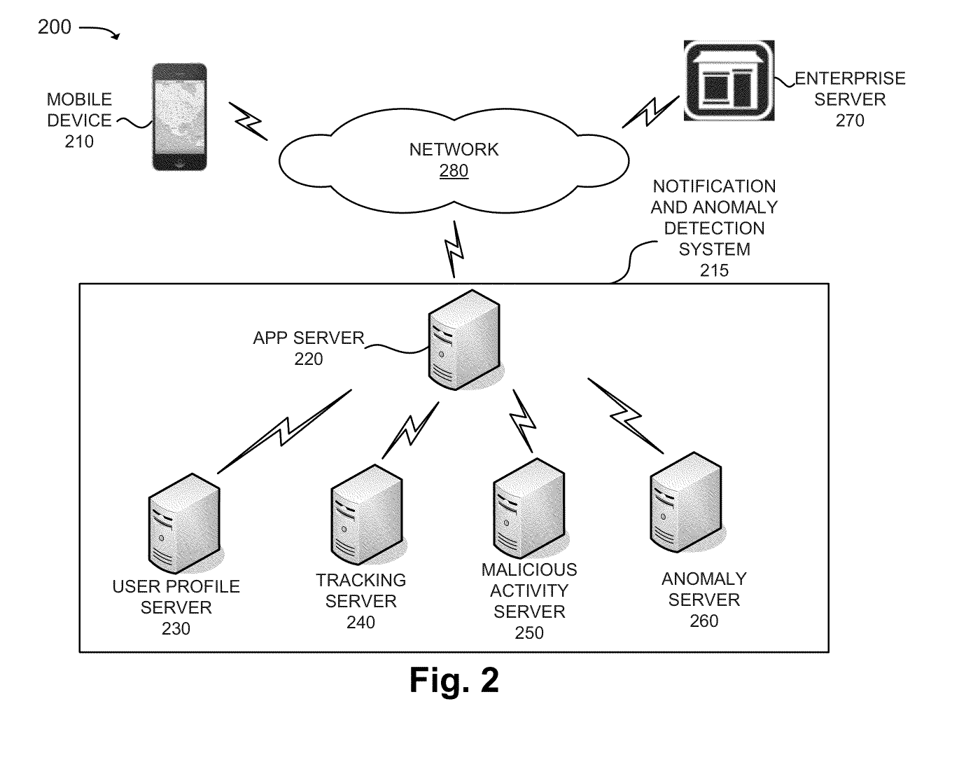

FIG. 2 is a diagram that illustrates an example environment 200 in which systems and/or methods, described herein, may be implemented. As shown in FIG. 2, environment 200 may include mobile device 210, notification and anomaly detection system 215, enterprise server 270, and network 280. As further shown, notification and anomaly detection system 215 may include application server 220 (“app server 220”), user profile server 230, tracking server 240, malicious activity server 250, and anomaly server 260. While FIG. 2 shows a particular number and arrangement of devices, in practice, environment 200 may include additional devices, fewer devices, different devices, or differently arranged devices than are shown in FIG. 2. Also, although certain connections are shown in FIG. 2, these connections are simply examples and additional or different connections may exist in practice. Each of the connections may be a wired and/or wireless connection. Further, mobile device 210 and enterprise server 270 may be implemented as multiple, possibly distributed, devices.

Mobile device 210 may include any device capable of communicating via a network. For example, mobile device 210 may correspond to a mobile communication device communication device (e.g., a mobile phone, a smart phone, a personal digital assistant (PDA), or a wireline telephone), a computer device (e.g., a laptop computer, a tablet computer, or a personal computer), a gaming device, a set top box, or another type of communication or computation device. Mobile device 210 may also include a mobile application or “app” that can be used to communicate with app server 220.

Notification and anomaly detection system 215, as described herein, can include one or more server devices that can provide information on a transaction and receive approval, denial, or requests for more information about the transaction from a user through a mobile device 210. For example, the notification and anomaly detection system 215 can monitor and notify the user about how, when, and where the user's identity is being accessed or used. For example, the notification and anomaly detection system 215 can notify a user that a purchase is being made with the user's credit card from a store at a particular location for a particular amount. Additionally, the notification and anomaly detection system 215, in conjunction with a user, the notification and anomaly system can approve, deny, and/or request further information on the purchase from the store. By providing the notification and anomaly detection system 215, as described herein, the user can directly and immediately control usage of user's identity to reduce or prevent malicious use of the user's identity.

As shown in FIG. 2, notification and anomaly detection system 215 can include one or more server devices, such as app server 220, user profile server 230, tracking server 240, malicious activity server 250, anomaly server 260, and/or enterprise server 270. Notification and anomaly detection system 215 may also include other servers (not shown) to provide other services. For example, servers can be provided that provide notification services, such as a notification server (e.g., a short message service (SMS) messaging server, a multimedia message service (MMS) messaging server, an e-mail server, etc.), or anomaly detection services, such as an anti-fraud server (e.g., an authentication server, a token server, etc.).

App server 220 may include one or more server devices, such as one or more computer devices, or a backend support system for communicating between a notification and anomaly detection system and a mobile application on mobile device 210. App server 220 can receive transaction information from enterprises and can send the transaction information to mobile device 210. App server 220 can also receive authentication from mobile device 210, and provide authentication to the enterprises that provided the transaction information.

User profile server 230 may include one or more server devices, such as one or more computer devices, to store user profile information for users and provide user profile information to app server 220. The user profile information may include various information regarding a user, such as login information (e.g., user identifier and password), billing information, address information, types of products and services which the user frequently purchases, a list of transactions completed by the user, a device identifier (e.g., a mobile device 210 identifier) for devices used by the user, geographic locations that the user frequents, or the like. The user profile information may be collected only with the user's express permission. App server 220 may use the user profile information to authenticate a user and may update the user profile information based on the user's activity (with the user's express permission), where data from user profile server 230 can be used by app server 220 to authenticate the user of mobile device 210 and to monitor and revise an identity profile on the user of mobile device 210.

Tracking server 240 may include one or more server devices, such as one or more computer devices, that work in combination with a GPS feature on mobile device 210 to track mobile device 210 locations and provide tracking information to app server 220. Tracking server 240 may be used to determine the location of mobile device 210, as well as compile a list of locations and movements of mobile device 210. For example, tracking server 240 may communicate with a GPS feature on mobile device 210 to determine the current location of mobile device 210, as well as past locations of mobile device 210. Tracking server 240 can compile and store the locations of mobile device 210, where data on the locations of mobile device 210 can be used by app server 220 to authenticate a user of mobile device 210 and to monitor and revise an identity profile on the user of mobile device 210.

Malicious activity server 250 may include one or more server devices, such as one or more computer devices, or a storage device, such as a database, that stores or processes information or other data on sources or activities that can be deemed malicious and can provide this information or data to app server 220 or anomaly server 260, for example. For example, malicious activity server 250 may gather information on malicious activity using, for example, public or private databases of fraudulent behavior or fraudulent enterprises. Malicious activity server 250 may also may receive transaction information from enterprise server 270, receive network security information from outside sources, perform fraud analysis with regard to the transaction information and in light of the network security information, and provide, to enterprise server 270 and/or mobile device 210, information regarding the results of the fraud analysis.

Malicious activity server 250 may also represent a collection of network security devices, such as network analyzers, firewalls, intrusion detection systems (IDSs), routers, gateways, proxy devices, servers etc., that provides network monitoring and/or protection services. Malicious activity server 250 may collect network security information, regarding malicious network activity within network 280, and provide the network security information to app server 220. Malicious activity server 250 may collect network security information for purposes independent of determining whether a particular transaction is potentially fraudulent. In other words, malicious activity server 250 may collect network security information as part of malicious activity server's 250 network security and/or protection functions, and independent of determining whether a particular transaction is potentially fraudulent.

In one implementation, malicious activity server 250 may create lists that may be used by app server 220. The lists may include information identifying enterprises (e.g., fictitious merchants, fraudulent dealers, etc.), devices (e.g., consumer devices and/or enterprise devices), and/or systems (e.g., enterprise websites) that have been associated with malicious network activity. In another implementation, the network security information may include information other than lists. Malicious activity server 250 may store the network security information in one or more memory devices accessible by app server 220. Alternatively, or additionally, malicious activity server 250 may transmit the network security information for storage by app server 220.

Anomaly server 260 may include one or more server devices, such as one or more computer devices, that can identify possible fraud or theft. Anomaly server 260 can utilize anti-fraud technologies, such as predictive analytics, to detect patterns and detect anomalies by comparing information gathered by app server 220 (e.g., information from other servers, such as transaction information, user profile information, tracking information, malicious activity) to transaction information from enterprise server 270, and can send anomaly information to app server 220.

In one implementation, anomaly server 260 can be a predictive analytics server used to find patterns and anomalies for one or more users. For multiple users, anomaly server 260 can identify patterns and anomalies based upon transaction information from network information, such as information associated with multiple users across the network 280 via app server 220 and/or transaction information from malicious activity server 250. For example, anomaly server 260 can gather transactional information from 10,000 users of a particular enterprise, and can use the transactional information to find patterns and anomalies about the particular enterprise (e.g., users spend $20 to $50 at the particular enterprise, so a user spending $1000 would be an anomaly to the pattern).

Additionally, or alternatively, for single users, anomaly server 260 can create patterns based upon transaction information from the user of mobile device 210, such as a single user's transaction information from user profile server 230 and tracking server 240. In one implementation, anomaly server 260 can gather transaction information for the user to find patterns and anomalies based upon transaction information from the user's transaction history from user profile server 230. For example, anomaly server 260 can gather historical transactional information for a user, can use the historical transaction information to find transactional patterns for the user, and can compare the transactional patterns for the user with individual transactions to find anomalies (e.g., a user historically spends $20 to $50 at a particular enterprise, so the user spending $1000 at the particular enterprise would be an anomaly to the pattern).

In another implementation, for single users, anomaly server 260 can gather transactional information from the user of mobile device 210 from tracking server 240. Anomaly server 260 can be used to compare location information from tracking server 240 to transactional information from enterprise server 270 to find anomalous behavior. For example, anomaly server 260 can find anomalous behavior if tracking server 240 determines that a user is located in California, but enterprise server 270 is providing transaction information for a transaction in New York. Additionally, anomaly server 260 can find anomalous behavior based upon comparing other information, such as store data regarding which entrance to the enterprise the user typically enters from, a path through the enterprise that the user typically takes, locations where the user may spend more time, shopping habits, spending limits, or other behavior, with location information from tracking server 240.

Enterprise server 270 may include one or more server devices, such as one or more computer devices, that can receive requests for online purchases, send transaction information, and receive authentications for transactions. For example, enterprise server 270 can communicate with mobile device 210 and app server 220 to authenticate a user for an online purchase. While a single enterprise server 270 is shown in FIG. 2, environment 200 may include multiple enterprise servers 270 associated with different entities (e.g., companies, organizations, etc.).

Network 280 may include any type of network or a combination of networks. For example, network 280 may include a local area network (LAN), a wide area network (WAN) (e.g., the Internet), a metropolitan area network (MAN), an ad hoc network, a telephone network (e.g., a Public Switched Telephone Network (PSTN)), a cellular network, an optical network (e.g., a FiOS network), or a combination of networks. In one implementation, network 280 may support secure communications between mobile device 210 and servers 220-270. These secure communications may include encrypted communications, communications via a private network (e.g., a virtual private network (VPN) or a private IP VPN (PIP VPN)), other forms of secure communications, or a combination of secure types of communications.

Network 280 in the above implementation may generally include logic to provide wireless access for mobile device 210, and to provide wired or wireless access for servers 220-270. Through network 280, mobile device 210 and/or servers 220-270 may, for instance, communicate with one another and/or access services available through IP network.

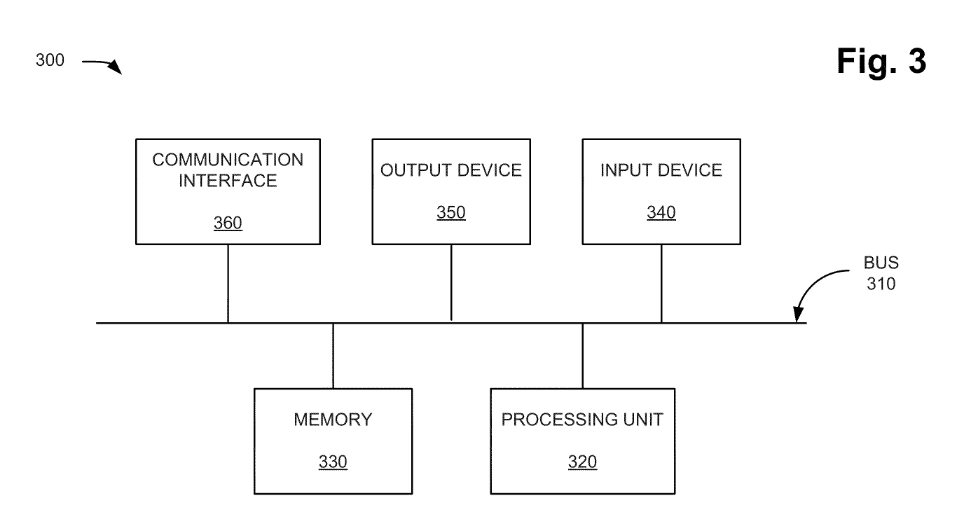

FIG. 3 is a diagram of example components of a device 300. Device 300 may correspond to mobile device 210, app server 220, user profile server 230, tracking server 240, malicious activity server 250, anomaly server 260, and/or enterprise server 270. Each of mobile device 210, app server 220, user profile server 230, tracking server 240, malicious activity server 250, anomaly server 260, and/or enterprise server 270 may include one or more devices 300.

As shown in FIG. 3, device 300 may include a bus 305, a processor 310, a main memory 315, a read only memory (ROM) 320, a storage device 325, an input device 330, an output device 335, and a communication interface 340. In another implementation, device 300 may include additional, fewer, different, or differently arranged components.

Bus 305 may include a path, or collection of paths, that permits communication among the components of device 300. Processor 310 may include a processor, a microprocessor, an application specific integrated circuit (ASIC), a field programmable gate array (FPGA), or another type of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a mechanism that permits an operator to input information to device 300, such as a control button, a keyboard, a keypad, or another type of input device. Output device 335 may include a mechanism that outputs information to the operator, such as a light emitting diode (LED), a display, or another type of output device. Communication interface 340 may include any transceiver-like mechanism that enables device 300 to communicate with other devices (e.g., mobile device 210) or networks. In one implementation, communication interface 340 may include a wireless interface or a wired interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include space within a single physical memory device or spread across multiple physical memory devices.

The software instructions may be read into main memory 315 from another computer-readable medium, such as storage device 325, or from another device via communication interface 340. The software instructions contained in main memory 315 may cause processor 310 to perform processes that will be described later. Alternatively, hardwired circuitry may be used in place of or in combination with software instructions to implement processes described herein. Thus, implementations described herein are not limited to any specific combination of hardware circuitry and software.

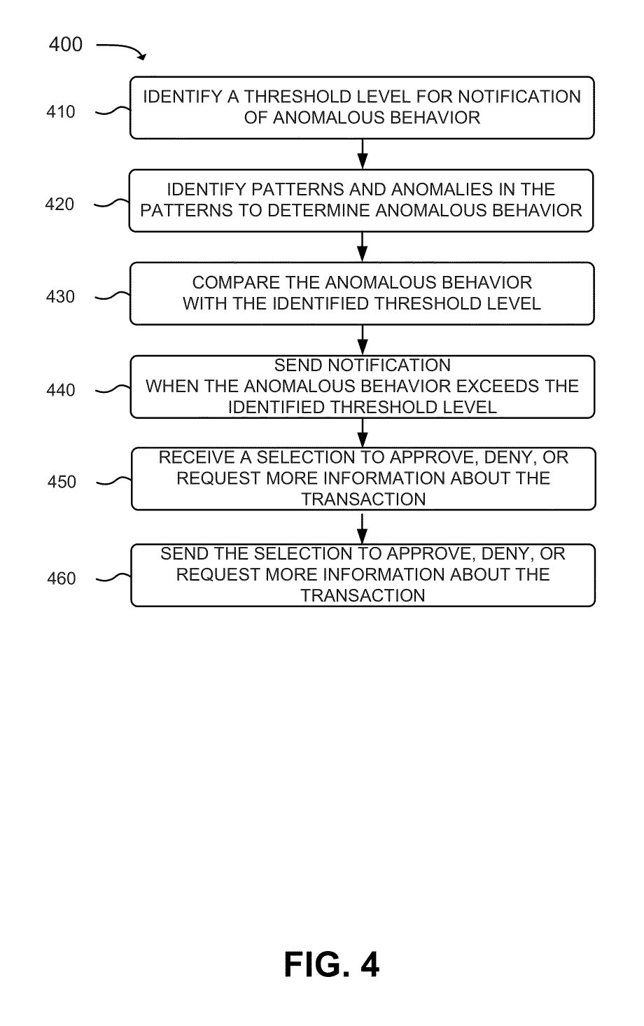

FIG. 4 is a flowchart of an example process 400 for providing a notification of anomalous behavior. In one implementation, process 400 may be performed by one or more components of mobile device 210, app server 220, user profile server 230, tracking server 240, malicious activity server 250, anomaly server 260, and/or enterprise server 270.

Process 400 may include identifying a threshold level for notification of anomalous behavior (block 410). The measure of risk for a transaction can be provided as a value that can be compared to the threshold set by the user. In one implementation, a high risk transaction, such as a transaction that is found to be anomalous based upon information from malicious activity server 250, can be assigned a different value than a low risk transaction, such as a transaction found to be anomalous based upon a small deviation from a user's pattern. For example, a scalar value can be assigned to the risk of a transaction, such as on a scale of 1 to 5 with 1 indicating a low risk and 5 indicating a high risk.

A threshold for providing a notification can be based upon a user setting a notification threshold level. In one implementation, a user can set a notification threshold level by entering a scalar value or other quantifiable measure upon which a threshold can be utilized in conjunction with a scalar value of the risk of a transaction.

Additionally, or alternatively, a user can be presented with an interface and can select to have a notification threshold based on the same or similar scale to the scale on which the risk of a transaction is measured. In one implementation, a user can select a notification threshold level based on a number or a description. For example, a user interface can be provided that allows a user to choose 4 on the same scale of 1 to 5 as the transaction risk levels or medium high on a scale of low to high, and can be notified when a transaction has a risk value of 4 or higher (e.g., a risk value of 5).

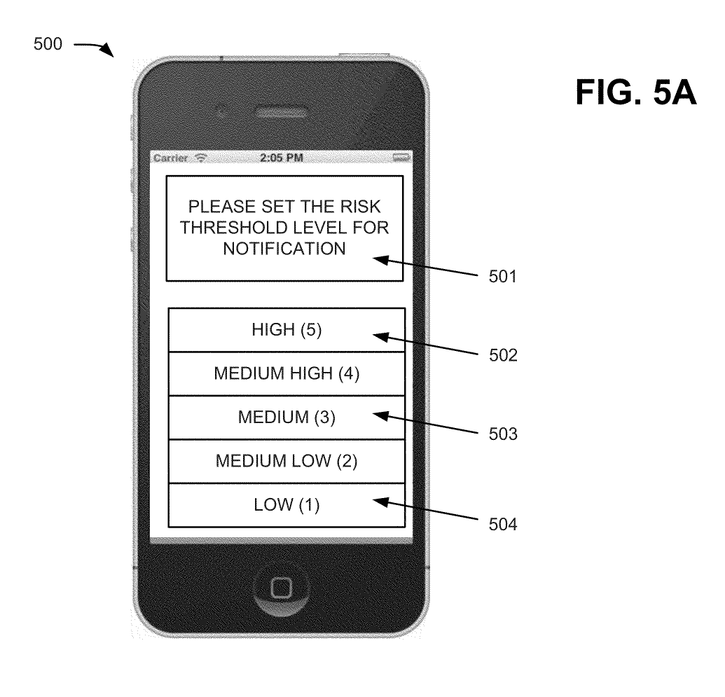

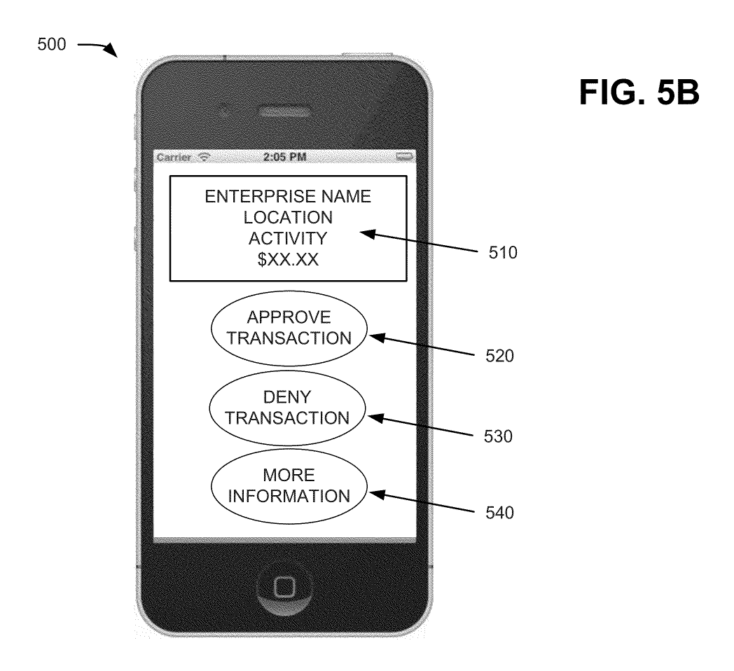

FIG. 5A illustrates an example user interface 500 that allows for a user to set a notification threshold level. As illustrated in FIG. 5A, user interface 500 can display a prompt 501 that requests a user to set the risk threshold level, such as making a selection between the options of: HIGH (5) 502, MEDIUM HIGH (4), MEDIUM (3) 503, MEDIUM LOW (2), and LOW (1) 504. The optional levels can include any set of values, such as 1 to 3, 1 to 5, 1 to 100, etc., or descriptive measures, such as low/high, low/medium/high, etc.

The user can select whether to be notified when a transaction's risk level is above a particular notification threshold level. For example, a user can select HIGH (5) 501 as the notification threshold level and the user can be provided with a notification when a transaction has a high risk level. Alternatively, a user can select MEDIUM (3) 503 and the user can be provided with a notification when a transaction has a medium, a medium high, or a high level of risk. Alternatively, a user can select LOW (1) 504 and the user can be provided with a notification when a transaction has a low, a medium low, a medium, a medium high, or a high level of risk.

In another implementation, a first threshold level can be set, and a user can be allowed to change the first threshold level to a second threshold level. For example, the first threshold level can be set to 3 on the scale of 1 to 5 discussed above (e.g., notifications for medium to high risk transactions), and the user can change the first threshold level to a second threshold level of 1, such that the user will be notified of transactions with risk values of 1 or higher (e.g., low to high risk transactions). A user may want to lower the threshold level if the user's identity may be compromised (e.g., set the threshold level low to receive more notifications of transactions) or raise the threshold level if the notifications are too cumbersome (e.g., receiving too many notifications for authorized transactions).

Returning to FIG. 4, process 400 may include identifying patterns and anomalies in the patterns to determine anomalous behavior (block 420). In one implementation, a pattern can be recognized based on a transactional history of a single user and/or transactions of multiple users, as discussed above. Anomalies can be identified by comparing transaction information for a user with the patterns based on the transaction history of the user and/or multiple users, and recognizing when transactions are anomalous to the pattern. Anomalous behavior can be determined when one or more anomalies are found in one or more patterns.

Additionally, or alternatively, anomalous behavior can be identified by comparing user activity information with databases of places, enterprises, or activities that are known to be associated with malicious behavior (e.g., places, enterprises, or activities that are known to be sources of identity theft, viruses, malware, etc.). If the user activity information appears to be from a place associated with malicious behavior, then the user activity can be identified as a very high level of anomalous behavior. For example, the anomalous behavior signal can have a scalar value of 5 out of 5 with 5 being the most dangerous level of anomalous behavior and 1 being the least dangerous level of anomalous behavior.

In one implementation, anomalous behavior can be determined by, for example, gathering historical malicious behavior information from a database of malicious behavior, comparing the user activity information with the historical malicious behavior information, and determining that the user activity information is an anomalous behavior signal when the user activity information compared to the historical malicious behavior information exceeds a threshold level.

Additionally, or alternatively, identifying anomalies can be based on analytics, such as predictive analytics. In one implementation, predictive analytics can be used to find patterns from existing transactions. For example, predictive analytics can be used to build patterns based upon user activity information of a group of users, and determine that the user activity information is an anomalous behavior signal when the user activity information compared to the patterns exceeds a threshold level.

Predictive analytics can be provided by one or more server devices, and can be used to analyze large amounts of data to find small numbers of anomalies. For example, 10,000 transactions can be analyzed using predictive analytics, and 9,980 can fit a pattern with 20 transactions that do not fit the pattern. These 20 transactions can be analyzed for maliciousness with a higher likelihood than the 9,980 assuming that the vast majority are non-malicious transactions. Predictive analytics can also be used for financial patterns, location movement patterns, mobile phone activity patterns, etc., and can identify anomalies when inconsistencies in the patterns are found.

Predictive analytics can also provide risk analysis for anomalies. In one implementation, anomalies that are found can be anomalous to a pattern, but can be part of a separate pattern of anomalous behavior. For example, transactions can be monitored and anomalies in the pattern can be found. The anomalies in the pattern can have similarities with other anomalies in the pattern, and based upon the risk of one or more anomalies, a risk of other anomalies can be provided.

Process 400 may include comparing the anomalies with the identified threshold level for notification of anomalous behavior (block 430). Comparing the anomalies with the identified threshold level for notification of the anomalies can occur by converting the risk of the anomalies and/or the identified threshold level into comparable values. In one implementation, comparing the anomalous behavior signal with the identified threshold level for notification of anomalous behavior can include converting the risk of the anomalous behavior to a scalar value and comparing the risk of the anomalous behavior's scalar value to a scalar value of the identified threshold level. For example, a risk of an anomalous behavior can be converted into a scalar value of 4 on a scale of 1 to 5 (e.g., medium-high risk), and the scalar value of the identified threshold level can be 2 on a scale of 1 to 5 (e.g., low-medium risk), such that the risk of the anomalous behavior can exceed the threshold level.

Process 400 may include sending a notification of a risk of anomalous behavior when the anomalous behavior exceeds the identified threshold level (block 440). In one implementation, a notification can be sent when a scalar value (e.g., a 4 on a scale of 1 to 5) of the anomalous behavior signal exceeds the scalar value of the identified threshold level (e.g., a 2 on a scale of 1 to 5) for notification of anomalous behavior, as discussed above.

Additionally, notifications can be sent with an alert. In one implementation, a visual alert can be displayed as a notification. For example, a visual alert, such as a pop-up display or a banner, can be presented when the anomalous behavior exceeds the identified threshold level. Additionally, or alternatively, an audio alert can be presented via a speaker associated with mobile device 210, for example, when the anomalous behavior exceeds the identified threshold level.

FIG. 5B illustrates an example user interface 500 that provides a notification 510 of an anomalous behavior and allows a user of mobile device 210 to approve, deny, or request more information regarding the transaction underlying the notification according to an implementation. In FIG. 5B, the example user interface 500 provides a selection of choices in the form of interactive areas including: a notification about the anomalous behavior 510, an approval interactive area 520, a denial interactive area 530, and a request for more information interactive area 540.

In one implementation, notification 510 can include an enterprise's name (e.g., Best Buy®, Amazon®, etc.), a location (e.g., the address of the enterprise), a type of activity (e.g., purchase, subscription, rental, money transfer, etc.), an amount of money involved in the transaction, or any other information that may be useful to a user. For example, other information can include a risk level, a history of anomalous behavior for the enterprise, a requester's name, a reason for a request, etc.

In one implementation, selecting approval interactive area 520 can send a message to app server 220 and/or enterprise server 270 that can include authentication information (e.g., security codes, passwords, affirmative confirmations, etc.), and can allow the user activity (e.g., a purchase of an item, a change of status from anomalous behavior to authenticated behavior, etc.) to be completed. For example, for an online purchase, authentication from mobile device 210 can be in addition or in lieu of authentication online during the online transaction.

In one implementation, selecting denial interactive area 530 can send a message to app server 220 and/or enterprise server 270 with instructions to stop the transaction by declining or refusing authentication. Additionally, or alternatively, denial interactive area 530 can also be used to identify future anomalous behavior regarding the user or the transaction, for example. Additionally, or alternatively, selecting denial interactive area 530 can send a notification to security, such as a law enforcement branch or a credit bureau, that the enterprise submitting the transaction or the user of the identity may be committing a crime.

In one implementation, selecting request for more information interactive area 540 can send a message, to app server 220 and/or enterprise server 270, requesting more information about the transaction, the enterprise, the credit card being used, etc., such that the transaction can be better identified, for example.

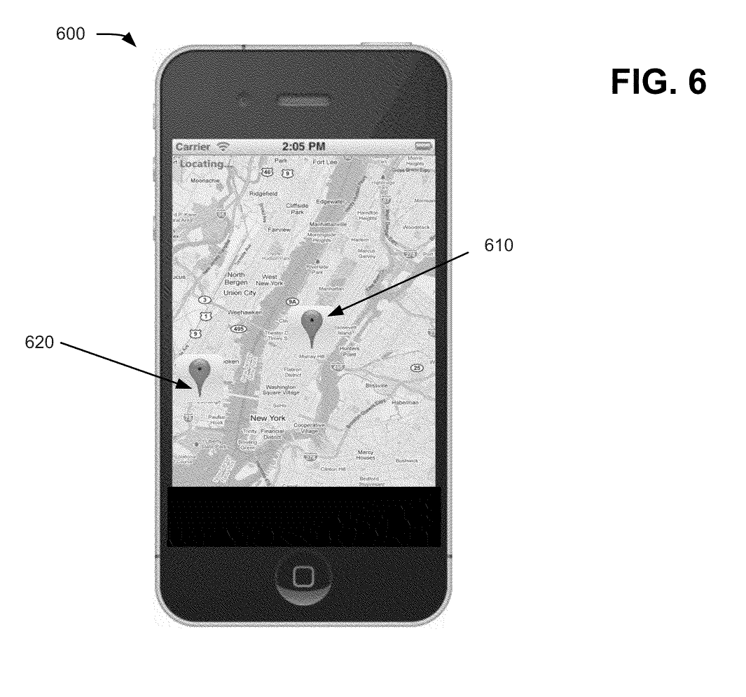

FIG. 6 illustrates an example user interface 600 that provides a visual notification of a location of a transaction. As illustrated in FIG. 6, a transaction location 610 can be shown on a map user interface 600 along with a present location 620 of mobile device 210 according to tracking server 240. In one implementation, upon receipt of a transaction by app server 220, app server 220 can provide a transaction location 610 on map interface 600 on mobile device 210. By providing a visual notification, such as a map user interface 600, a user may be able to identify a transaction as authentic or malicious with a glance at the map user interface 600 rather than having to read information. This might be beneficial in situations where the transaction occurs at a brick-and-mortar store.

Additionally, or alternatively, more information can be provided on user interface 600. In one implementation, information similar to information provided on user interface 500 can be provided on user interface 600. For example, along with a pin showing the location of transaction, the name of the enterprise, date, amount of the transaction, etc. can be displayed on user interface 600 or can be accessed through a user interacting with user interface 600 to review additional information.

Additionally, or alternatively, selecting to approve, deny, or request more information can be provided on user interface 600. In one implementation, interaction with the pin can provide a menu listing the options of approving, denying, or requesting more information.

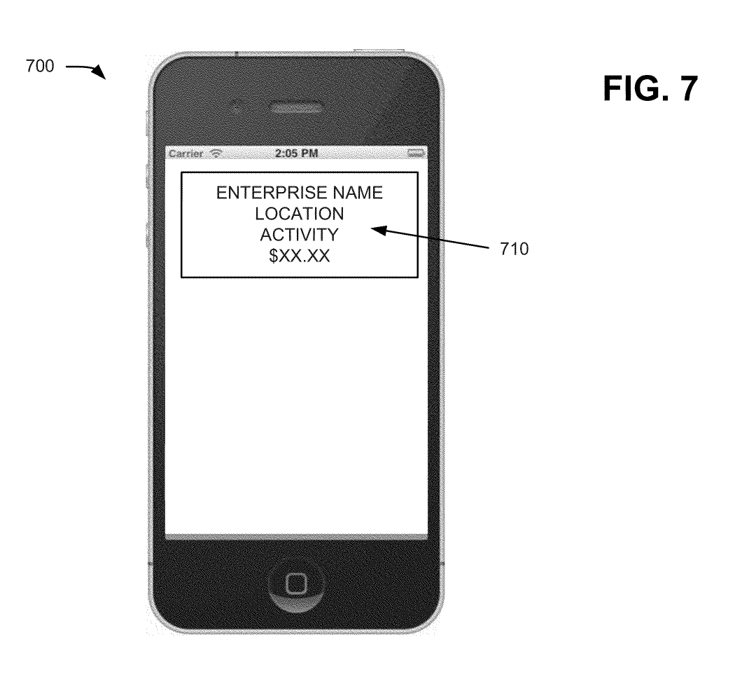

FIG. 7 illustrates an example user interface 700 that provides a notification 710 in the form of a message. In one implementation, notification 710 can include the enterprise name, location, activity, and amount, for example. Additionally, notification 710 can be any type of message that can provide notification of a transaction to mobile device 210, such as a text message, an email message, a pop-up screen, an automated telephone message, etc.

In one implementation, notification services can be provided with preferences to set the level at which notification can occur. For example, when financial information is being accessed, the user may want a text message. Therefore, a user can monitor the user's behavior or any malicious behavior on the user's behalf. For example, if you are in a meeting in San Francisco, you get a text message that you are withdrawing money from an automated teller in New York.

Additionally, or alternatively, rather than simply setting a threshold for all activities, the user can select a threshold per activity. For example, a user can set three thresholds: (1) the user can set threshold 1 to low for activities like money withdrawals (e.g., debits, ATM activities, stock sales, etc.); (2) the user can set threshold 2 to medium or high for credit card purchase; and (3) the user can set threshold 3 for new accounts opened (e.g., bank, credit card, etc.). The user could also set different types of notifications for each threshold. For example, the user could set an audible alert for threshold 1, an email alert for threshold 2, and a text message alert for threshold 3.

Returning to FIG. 4, process 400 may include receiving a selection to approve, deny, or request more information about the transaction (block 450). In one implementation, authentication via a selection of approve, deny, or request more information can be provided by mobile device 210 through a user interaction with mobile device 210. For example, a user can interact with a user interface on mobile device 210 (e.g., see FIG. 5B) and select to approve or authenticate an anomalous transaction as being authentic user activity information.

Process 400 may include sending the approval, denial, or request more information about the transaction (block 450). In one implementation, the approval, denial, or request more information about the transaction can be sent to the enterprise. For example, a user can approve a transaction, and an enterprise can complete the transaction without delay or further interaction with the user.

Alternatively, in one implementation, a user could deny a transaction, and the enterprise and/or associated financial institutions can be sent a message denying the transaction and/or identifying malicious activity. For example, a credit card purchase that is denied by the user can trigger a message to be sent to both the enterprise and the credit card company that there is fraudulent activity, allowing the enterprise and/or the credit card company to apprehend the person with the credit card or suspend all transactions for the credit card (and possibly any or all other uses of the user's identity, such as associated bank accounts, credit cards, etc.).

Alternatively, in one implementation, a user could request more information about a transaction and the enterprise and/or associated financial institutions can provide more information to the user and/or temporarily suspend activity on the user's account(s) until the transaction is approved or denied. For example, a user can request more information on a credit card purchase, and the credit card can be temporarily frozen until authorization is received, or can be permanently frozen if authorization is denied.

Systems and/or methods described herein may provide notification services related to transactions with enterprises. In one implementation, notification services can be provided when anomalies in behavior are detected, such as identity theft or fraud. For example, if a credit card number is being used in New York, but the owner of the credit card is located in California according to the owner's identity profile, then a notification to mobile device 210 can be sent.

Systems and/or methods described herein may also be used in conjunction with other notification services to forward notifications. In one implementation, credit card companies, ATMs, credit bureaus, or enterprises, may forward these notifications to app server 220, which in turn may send notifications from app server 220 to mobile device 210 and/or revise the identity profile.

The foregoing description of implementations provides illustration and description, but is not intended to be exhaustive or to limit the embodiments to the precise form disclosed. Modifications and variations are possible in light of the above embodiments or may be acquired from practice of the implementations described herein.

For example, while a series of blocks has been described with regard to FIG. 4, the order of the blocks may be modified in other implementations. Further, non-dependent blocks may be performed in parallel.

It will be apparent that embodiments, as described herein, may be implemented in many different forms of software, firmware, and hardware in the implementations illustrated in the figures. The actual software code or specialized control hardware used to implement embodiments described herein is not limiting of the embodiments. Thus, the operation and behavior of the embodiments were described without reference to the specific software code—it being understood that software and control hardware may be designed to implement the embodiments based on the description herein.

Further, certain portions of the embodiments may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the embodiments. In fact, many of these features may be combined in ways not specifically recited in the claims and/or disclosed in the specification.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
identifying, by one or more server devices, a notification threshold level;
identifying, by the one or more server devices, an anomalous transaction involving an enterprise;
comparing, by the one or more server devices, the anomalous transaction with the identified notification threshold level;
sending, by the one or more server devices via a network, a notification when the anomalous transaction exceeds the identified notification threshold level;
receiving, by the one or more server devices, a selection to approve, deny, or request more information about the anomalous transaction; and
sending, by the one or more server devices to the enterprise via the network, the selection to approve, deny, or request more information about the anomalous transaction.

2. The method of claim 1, where identifying the notification threshold level comprises:
receiving input from a user identifying the notification threshold level; or
predetermining a first notification threshold level, and allowing a user to change the first notification threshold level to set a second notification threshold level as the notification threshold level.

3. The method of claim 1, where identifying the anomalous transaction comprises:
building an identity profile for a user by gathering user identity information data and/or user tracking information data;
gathering transaction data;
comparing the identity profile with the transaction data; and
determining that the transaction is an anomalous transaction when the transaction data deviates by a predetermined amount from data from the identity profile.

4. The method of claim 1, where identifying the anomalous transaction comprises:
gathering transaction data;
gathering historical malicious behavior data;
comparing the transaction data with the historical malicious behavior data; and
determining that the transaction is an anomalous transaction when the transaction data deviates by a predetermined amount from the historical malicious behavior data.

5. The method of claim 1, where identifying the anomalous transaction comprises:
building a pattern based upon a plurality of transaction data and/or identity data from a user;
receiving transaction information on a transaction;
comparing the transaction information to the pattern; and
determining that the transaction is an anomalous transaction when the transaction information deviates by a predetermined amount from the pattern.

6. The method of claim 1, where identifying the anomalous transaction comprises:
building a pattern based upon a plurality of transaction data from multiple users;
receiving transaction information on a transaction;
comparing the transaction information to the pattern; and
determining that the transaction is an anomalous transaction when the transaction information deviates by a predetermined amount from the pattern.

7. The method of claim 1, further comprising:
converting the identified notification threshold level to a value on a notification threshold level scale;
receiving anomalous transaction data; and
converting the anomalous transaction data to a value on the notification threshold level scale, where comparing the anomalous transaction with the identified notification threshold level comprises: comparing the anomalous transaction data value to the identified notification threshold level value.

8. The method of claim 1, further comprising:
preparing, when the notification exceeds the identified notification threshold level, an alert associated with the notification; and
presenting a visual alert via a display associated with a mobile device, or presenting an audible alert via a speaker associated with the mobile device.

9. The method of claim 1, where identifying the anomalous transaction comprises:
receiving transaction information;
receiving comparative information from the one or more server devices;
comparing the transaction information with the comparative information; and
identifying anomalies based upon inconsistencies between the transaction information and the comparative information from the one or more server devices.

10. The method of claim 9, where receiving the comparative information from the one or more server devices comprises receiving login information, billing information, address information, previous purchase history, a listing of transactions, information identifying a location of a mobile device, and/or information identifying previous locations of the mobile device.

11. The method of claim 9, where receiving the comparative information from the one or more server devices comprises receiving comparative information from the tracking server, where the comparative information includes information identifying a location of the device, a list of previous locations of the device, and/or information identifying movements of the device.

12. The method of claim 9, where receiving the comparative information the one or more server devices comprises receiving information on enterprises, devices, and/or systems associated with malicious activity.

13. The method of claim 1, further comprising:
preparing a first map icon based upon a location of the anomalous transaction;
preparing a second map icon based upon a location of a device; and
providing a user interface that includes a map illustrating the first map icon on the map, and the second map icon on the map.

14. The method of claim 13, further comprising:
providing anomalous transaction information with the first map icon, the anomalous transaction information including a name and a location of an enterprise providing the anomalous transaction,
where receiving the selection to approve, deny, or request more information about the anomalous transaction is received through interaction with the user interface that includes the map.

15. A device, comprising:
at least one processor to:
present a first user interface displaying a plurality of threshold levels for selection;
receive a selection of a threshold level from the plurality of threshold levels;
receive, via a network, a notification of anomalous behavior when an anomalous behavior risk level, that is based upon information about a transaction, exceeds the selected threshold level;
present a second user interface displaying the notification of anomalous behavior;
receive, via the second user interface, options to approve, deny, or request more information about the transaction; and
send, via the network, a selection of one of the options to approve, deny, or request more information about the transaction.

16. The device of claim 15, where the least one processor is to further:
generate an alert based on the notification of anomalous behavior; and
provide the alert on the device.

17. The device of claim 16, where, when providing the alert, the at least one processor is to:
present a visual notification via a display associated with the device, or present an audible notification via a speaker associated with the device.

18. A system, comprising:
one or more server devices with one or more processors to:
monitor financial and/or identification inquiries for anomalous behavior;
identify anomalous behavior by comparing the financial and/or identification inquiries to historical financial transactions and/or identification information;
send a notification to a mobile device when anomalous behavior is identified for a user of the mobile device; and
receive a signal from the mobile device approving, denying, or requesting more information about the anomalous behavior.

19. The system of claim 18, where the one or more server devices are to identify anomalous behavior by comparing the financial and/or identification transactions to identification information, which includes login information, billing information, address information, previous purchase history, a listing of transactions, information identifying a location of the mobile device, and/or information identifying previous locations of the mobile device.

20. A method comprising:
selecting, by a mobile device, a plurality of notification threshold levels;
sending, by the mobile device via a network, the plurality of notification threshold levels;
receiving, by the mobile device via the network, a notification when an anomalous transaction exceeds at least one of the plurality of notification threshold levels;
providing, by the mobile device, a first audible and/or visual alert when the anomalous transaction exceeds a first of the plurality of notification threshold levels; and
providing, by the mobile device, a second audible and/or visual alert when the anomalous transaction exceeds a second of the plurality of notification threshold levels.

21. The method of claim 20, where the selecting the plurality of notification threshold levels includes selecting the first and the second notification threshold levels and selecting a type of audible and/or visual alert associated with each of the first and the second notification threshold levels, respectively,
where providing the first audible and/or visual alert comprises providing an audible alert via a speaker associated with the mobile device and/or a visual alert via a display associated with the mobile device when the anomalous transaction exceeds the first of the plurality of notification threshold levels, and
where providing the second audible and/or visual alert comprises providing an audible alert via the speaker associated with the mobile device and/or a visual alert via the display associated with the mobile device when the anomalous transaction exceeds the second of the plurality of notification threshold levels.
